(19) United States
(12) Patent Application Publication
(10) Pub. No.: US 2012/0000715 A1
(43) Pub. Date: Jan. 5, 2012

(54) WEIGHING APPARATUS AND METHOD FOR WEIGHING VEHICLES

(76) Inventor: Fathi Saigh, Laval (CA)

(21) Appl. No.: 13/256,772

(22) PCT Filed: Mar. 19, 2010
(86) PCT No.: PCT/CA10/00440

§ 371 Date: Sep. 15, 2011

Related U.S. Application Data
(60) Provisional application No. 61/161,874, filed on Mar. 20, 2009.

(51) Int. Cl. G01G 19/02; G01G 19/32; G01G 19/08

(52) U.S. Cl. 177/25.18; 177/136; 177/199

(57) ABSTRACT

A portable weighing apparatus comprises a portable platform body. The platform body has a top surface adapted to support a wheel of a vehicle/trailer when the platform body lies on the ground. A weight sensor related to the top surface of the platform body produces a weight signal as a function of a weight of the wheel and vehicle/trailer on the platform body. A weighing processor outputs a weight value from the weight signal. A load sensor has a trigger portion generally centrally located in a direction on the top surface of the platform body. The load sensor actuates a measurement from the weight sensor when triggered. A system for weighing a vehicle/trailer and a method for measuring the weight of a wheel and vehicle/trailer are also provided.

### CROSS-REFERENCE TO RELATED APPLICATION(S)

The present application claims priority on U.S. Patent Application No. 61/161,874, filed on Mar. 20, 2009, and incorporated herein by reference.

### FIELD OF THE APPLICATION

The present application relates to apparatuses for the weight measurement of vehicles such as tractor/trailer combinations, for instance to weigh the load of a trailer.

### BACKGROUND OF THE ART

For various reasons, vehicles must occasionally be weighed. Load restrictions on roads, and measurements of the content of a loaded trailer, are reasons amongst numerous others why weight measuring systems are used.

One weight measuring system comprises a vehicle-size scale. The scale has a platform that is large enough to support a full vehicle. Considering that it is often large vehicles that must be weighed (e.g., 18-wheel vehicles), such measuring systems are inconvenient in terms of the required infrastructure, and are limited to being at a fixed location.

As an alternative, some weight measuring systems comprise numerous platforms, with a platform being positioned under each wheel of the vehicle. Accordingly, the vehicle is fully supported by the platforms. Therefore, the addition of the weight measurement of each platform forms the weight of the vehicle. This alternative is practical as it does not require infrastructure as does the vehicle-size scale. However, installing platforms under each wheel is costly in terms of time and manpower.

### SUMMARY OF THE APPLICATION

It is therefore an aim of the present application to provide a novel portable weighing apparatus.

Therefore, in accordance with a first embodiment of the present application, there is provided a portable weighing apparatus comprising: a portable platform body having a top surface sized to be adapted to support at least one wheel of a vehicle/trailer when the platform body lies on the ground; a weight sensor related to the top surface of the platform body to produce a weight signal as a function of a weight of the wheel and vehicle/trailer on the top surface of the platform body; a weighing processor to output a weight value from the weight signal; and at least one load sensor having a trigger portion generally centrally located in a direction on the top surface of the platform body to actuate a measurement from the weight sensor when triggered.

Further in accordance with the first embodiment, at least one peripheral sensor is positioned peripherally with respect to the platform body to prevent a measurement from the weight sensor when triggered.

Still further in accordance with the first embodiment, at least one of the peripheral sensor is a tip sensor projecting laterally from a side of the platform body and adapted to detect the pressure of objects thereon, the tip sensor adapted to support the weight of the wheel when the wheel rolls onto the top surface of the platform body.

Still further in accordance with the first embodiment, a ramp surface is oriented from the ground to the top surface of the platform body and encloses the tip sensor.

Still further in accordance with the first embodiment, two of the ramp surface are positioned on opposed sides of the platform body.

Still further in accordance with the first embodiment, at least one of the peripheral sensor is a mat projecting beyond at least two sides of the platform body, the mat incorporating sensor means to detect the pressure of objects thereon.

Still further in accordance with the first embodiment, an alarm indicates a measurement being taken by the weight sensor.

Still further in accordance with the first embodiment, the alarm is at least one of an audible alarm, and a visual alarm.

Still further in accordance with the first embodiment, an interface in the portable weighing apparatus, outputs the weight value at the portable weighing apparatus.

Still further in accordance with the first embodiment, the interface comprises at least one of a digital display and a printer.

Still further in accordance with the first embodiment, the weighing processor comprises memory means to store weight values to calculate a total weight value for the vehicle/trailer after weighing each said wheel.

Still further in accordance with the first embodiment, connection means on the portable platform body removably attach the platform body to the vehicle/trailer as a fender by the connection means.

Still further in accordance with the first embodiment, the connection means comprise an actuator for displacing the platform body between a fending position and a weighing position.

Still further in accordance with the first embodiment, a transmitter for wirelessly transmitting the weight value to an interface unit is remotely located with respect to the portable weighing apparatus.

In accordance with a second embodiment of the present application, there is provided a system for weighing a vehicle/trailer, comprising: at least one of the portable weighing apparatus; and an interface unit remotely located with respect to the portable weighing apparatus, the interface unit comprising a processor for obtaining the weight value, and a display interface for displaying the weight remote.

Further in accordance with the second embodiment, the interface unit comprises a receiver for receiving the weight value from the transmitter of the at least one portable weighing apparatus.

Still further in accordance with the second embodiment, the interface unit comprises a weight interpreter for at least one of storing weight values to calculate a total weight value for the vehicle/trailer after weighing each said wheel, and for identifying the one of multiple portable weighing apparatuses sending a weight value.

Still further in accordance with the second embodiment, the processor of the interface unit has a distance calculator to calculate a distance between the at least one portable weighing apparatus and the interface unit, and wherein the display interface produces an alarm if the calculated distance is beyond a threshold value.

Still further in accordance with the second embodiment, the interface unit receives a signal from the processing unit to display on the display interface that a measurement is being taken by the weight sensor.

In accordance with a third embodiment of the present application, there is provided a method for measuring the weight of a wheel and vehicle/trailer comprising: positioning a platform body of a weighing apparatus adjacent to a wheel of a vehicle/trailer; driving the wheel onto the platform body of the weighing apparatus; stopping the driving upon receiving a signal that the wheel is in a position to be weighed on the platform body; driving the wheel off the platform body; and repeating the sequence for at least another wheel of the vehicle/trailer.

Further in accordance with the third embodiment, repeating the sequence is done simultaneously for different wheels of the vehicle/trailer, by using at least two of the weighing apparatus.

Still further in accordance with the third embodiment, positioning the platform body adjacent to the wheel comprises lowering the platform body from a fending position on the vehicle/trailer.

Still further in accordance with the third embodiment, a total weight for the vehicle/trailer is received after weighing each said wheel of the vehicle.

### BRIEF DESCRIPTION OF DRAWINGS

FIG. 1 is a block diagram of a portable weighing apparatus with a user interface in accordance with an embodiment of the present disclosure;

FIG. 2 is a side view of the portable weighing apparatus of FIG. 1;

FIG. 3 is a schematic view of a vehicle equipped with the portable weighing apparatus in a fending position;

FIG. 4 is a schematic front view of the portable weighing apparatus in accordance with one embodiment;

FIG. 5 is a schematic front view of the portable weighing apparatus in accordance with another embodiment;

FIG. 6 is a schematic front view of the weighing apparatus of FIG. 4 being deployed to a weight measuring position;

FIG. 7 is a schematic front view of the weighing apparatus of FIG. 4 in the fending position;

FIG. 8 is a schematic view of the vehicle of FIG. 3, equipped with the weighing apparatus in the weight measuring position; and

FIG. 9 is a schematic assembly view of one of the weighing apparatus with respect to a support of the vehicle.

### DESCRIPTION OF PREFERRED EMBODIMENTS

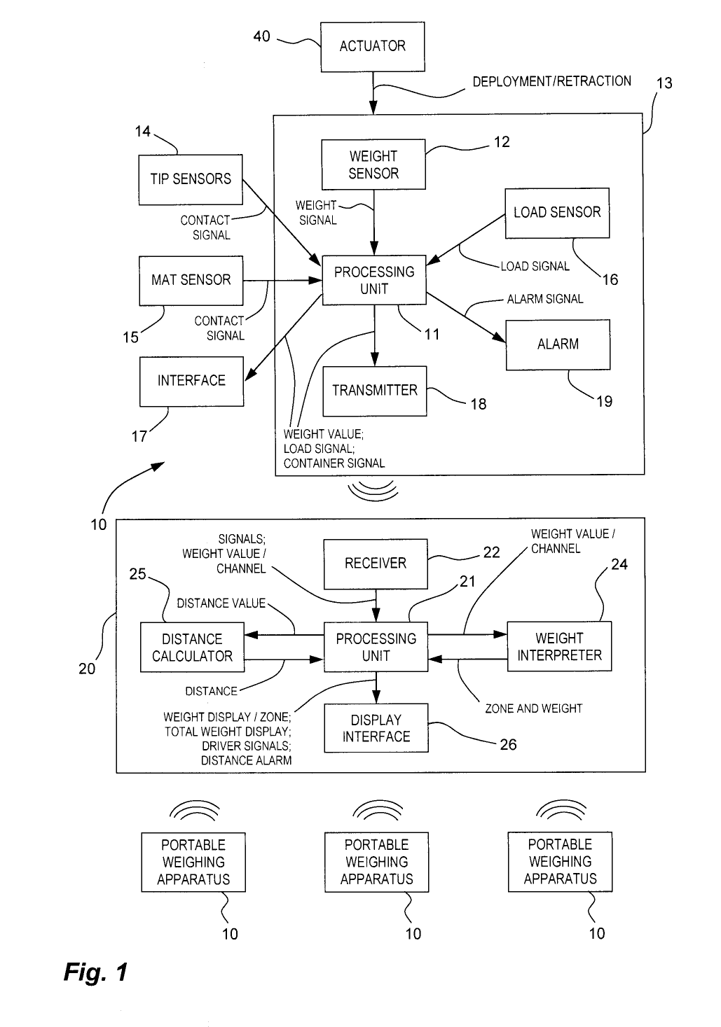

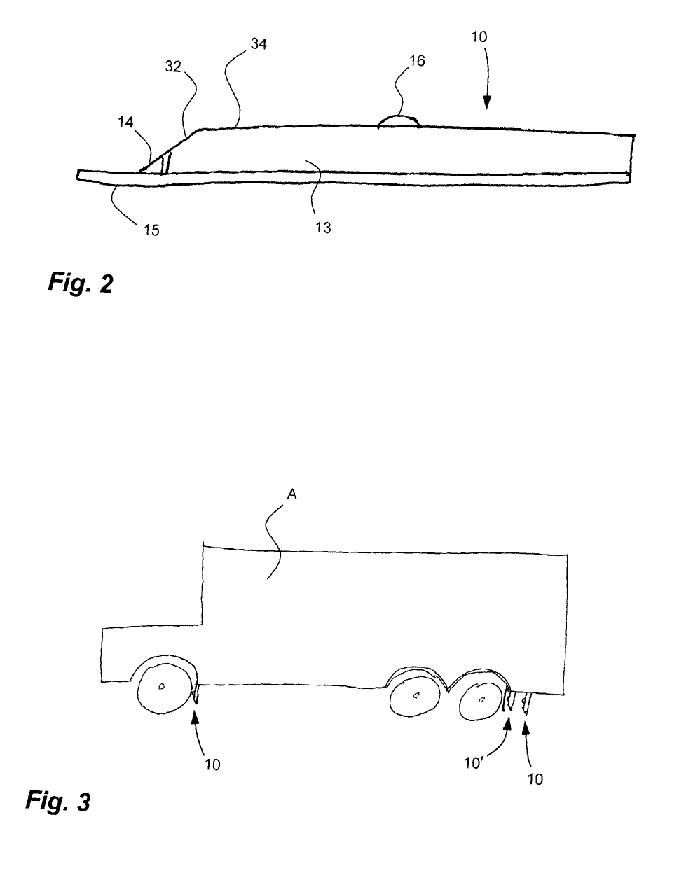

Referring to the drawings, and more particularly to FIGS. 1 and 2, a portable weighing apparatus in accordance with an embodiment of the present application is generally shown at 10. The portable weighing apparatus 10 is in the form of a portable mat or platform that is manually displaceable. Accordingly, the portable weighing apparatus 10 is particularly suited for use with tractors and trailers, for instance in the configuration of a tractor hitching a trailer. The weighing apparatus 10 is used to weigh parts of the trailer and tractor, for instance to determine the overall weight of a vehicle and hence the weight of a load carried by the trailer.

Referring to FIG. 1, various electronic components that can be used in the portable weighing apparatus 10 are illustrated. The electronic components and appropriate source are typically integrally molded into the material of the portable weighing apparatus 10, or enclosed inside the casing of the apparatus 10. The apparatus 10 is preferably made out of a metallic material or a polymeric substance, amongst other possibilities. It is pointed out that the conditions in which the portable weighing apparatus 10 is used may be harsh, and involve water, humidity, dirt, etc, whereby the apparatus 10 must be capable of operating in such conditions.

The portable weighing apparatus 10 has a processing unit 11 that receives a weight signal from a weight sensor unit 12. Both the processing unit 11 and the sensor unit 12 are at least partially in the platform body 13 of the portable weighing apparatus 10. The platform body 13 is therefore a flat rigid casing or mat, capable of sustaining the weight of a truck. Moreover, the platform body 13 must preferably be light enough so as to be manually transportable by a single person.

The processing unit 11 therefore comprises the necessary electronics to treat the weight signal for transmission or display. The weight sensor unit 12 may be any of a load cell, pressure sensor, or any other suitable sensor.

In addition to the weight sensor 12, the portable weighing apparatus 10 may have one or more tip sensors 14, as a form of peripheral sensor. The tip sensor 14 is connected to the processing unit 11, and is used to indicate if the wheel of a vehicle is fully supported on the top surface of the apparatus 10. More specifically, if the tip sensor 14 is triggered, it is because the wheel exerts pressure thereon. Therefore, the weighing apparatus 10 will not take a weight measurements if the tip sensor 14 is triggered.

Referring concurrently to FIGS. 1 and 2, the portable weighing apparatus 10 may also have a mat sensor 15 as another form of peripheral sensor, extending beyond the periphery of the platform body 13 of the portable weighing apparatus 10. The mat sensor 15 is a pressure sensitive mat or carpet that indicates if pressure is applied thereon. Again, in similar fashion to the tip sensors 14, the mat sensor 15 is used to indicate if the wheel of a vehicle is fully supported on the top surface of the apparatus 10, and not partially thereon, to ensure the precise measurement of the wheel.

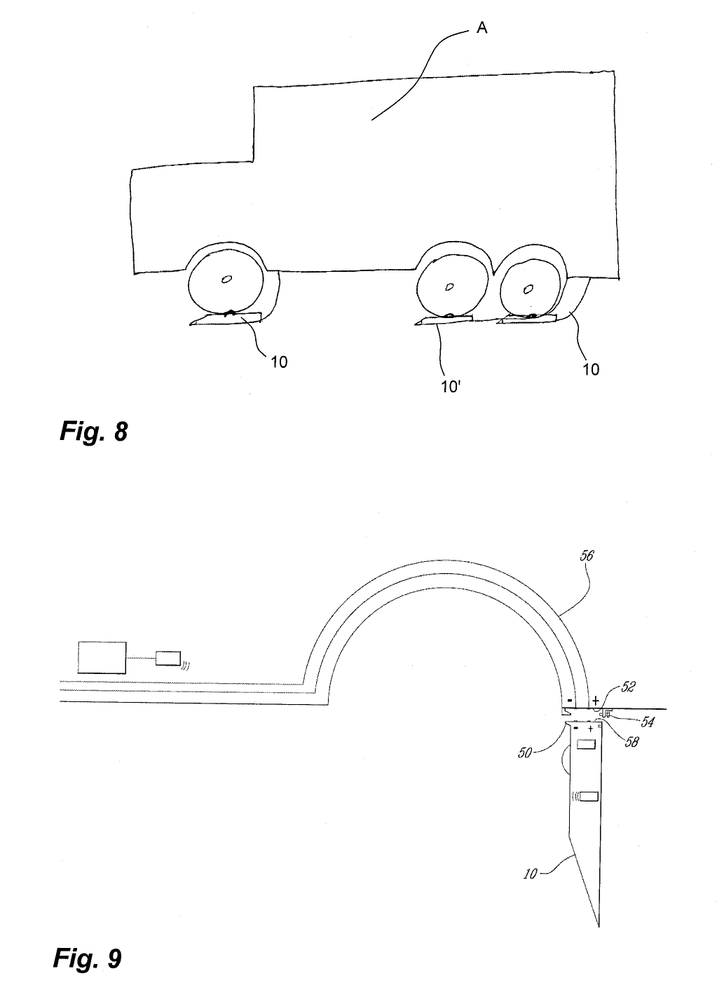

A load sensor 16 is provided on the top surface of the platform body 13 of the portable weighing apparatus 10, and may project upwardly from the top surface. The load sensor 16 is generally centrally located in the top surface of the platform body 13 (i.e., closer to a center of the top surface than to the periphery, along a wheel path on the top surface). The load sensor 16 may be a trigger switch (or any other appropriate switch) provided to indicate to the driver that the wheel has reached an appropriate weight measuring position on the platform body 13 of the apparatus 10, as illustrated for instance in FIG. 8, and thus is centrally located in the top surface. Accordingly, the driver may stop moving the vehicle. Considering that the platform body 13 of the apparatus 10 may be wide enough to cover two side-by-side wheels simultaneously, more than one load sensor 16 may be provided in the apparatus 10 to ensure that the two wheels are on the apparatus 10 in the weight measuring position. Any appropriate type of switches may be used, such as load cells, on/off switches, hydraulic, pneumatic or like pressure sensors.

In the embodiment of FIG. 1, an interface 17 is provided directly connected to the platform body 13 of the apparatus 10, or inside the platform body 13. The interface 17 is for instance a display unit and/or a printer that outputs a weight value. The interface 17 may be turned on by the triggering of the load sensor 16. The display unit and/or printer of the interface 17 may provide individual weight measurements, or a total value. The absence of action for a predetermined amount of time may prompt the processing unit 11 to calculate the total value. Moreover, interface keys may be provided in the interface 17 for the user to select the desired information. The interface 17 may also indicate a low level of energy of the portable weighing apparatus 10 operates on batteries.

A transmitter 18 may also be provided to wirelessly transmit information from the portable weighing apparatus 10 to an interface unit 20. Alternatively, the apparatus 10 may be wired to the interface unit 20, for instance if the interface unit 20 is in a measuring station.

An alarm 19 may be provided as part of the apparatus 10 as an interface for the vehicle driver. The alarm 19 may take any appropriate form (e.g., sound alarm such as a buzzer, a visual alarm such as a light source, or both). The alarm 19 may indicate that the load sensor 16 is triggered, whereby the driver may stop the vehicle for the weight measurement to be taken. Moreover, the alarm 19 may indicate that the weight measurement is complete, whereby the driver may displace the vehicle to get another wheel measured, or drive away when the measuring operations are completed.

If the cabin of the vehicle is equipped with an interface unit 20, the alarm may be part of the interface unit 20 and thus be inside the cabin.

It is also considered to use multiple apparatuses 10 to simultaneously measure the weight of the tractor/trailer at each contact point thereof with the ground. In such a case, the interface unit 20 gathers the data from the apparatuses 10 and centrally displays the individual weight measurements, and/or the sum of all measurements. FIG. 1 shows four portable weighing apparatuses 10 for the interface unit 20, but more or less portable weighing apparatuses 10 may be used. Moreover, the portable weighing apparatuses 10 may be wired to the interface unit 20, as mentioned above.

In the embodiment in which the portable weighing apparatus 10 has its own interface 17, the weight of the vehicle is obtained using the data output by the interface 17 (e.g., noted from the digital display, or obtained in paper format from the printer).

The interface unit 20 has a processing unit 21 that receives signals from a receiver 22. The receiver 22 is in wireless communication with the transmitters 18 of each apparatus 10. It is preferred that each apparatus 10 has an identification such that the interface unit 20 may identify which apparatus 10 is transmitting information. For instance, each apparatus 10 may have an own channel or a signaled address.

The processing unit 21 therefore receives the weight value signal, the contact signal, and/or the load signal. The weight value signal is forwarded to a weight interpreter 24. The weight interpreter 24 will calculate the weight and identify the zone of the weight. For instance, the weight interpreter 24 identifies the channel used to transmit a weight value, and provides the weight (e.g., in tons, kg, lb or the like) and the zone of the measured weight (e.g., rear left-side wheels).

The interface unit 20 may be programmed to alarm the driver that the apparatus 10 is at a given distance from the vehicle. In an embodiment, the interface unit 20 has a distance calculator 25 that calculates a distance between the weighing apparatus 10 and the interface unit 20, and alarms the driver if the distance is above a given threshold value. It may be desired to provide the apparatus 10 and the interface unit 20 with the appropriate detection members (e.g., GPS) to alarm the driver. The alarm 19 may be used for this purpose as well.

The interface unit 20 has a display interface 26 that is used to display the information to the driver. For instance, the weight per zone, the total weight (i.e., the addition of the weights of all apparatuses 10), as well as the backing up/moving forward and stop signals, respectively from the tip sensors 14, the mat sensor 15 and the load sensors 16, are provided to the driver. It is considered to provide the two different types of interface units 20. A first one would be in the vehicle cabin to display the backing up and stop signals to the driver, whereas a second one would be provided to an operator outside of the vehicle to note the weight data. The display interface 26 may indicate the level of power in the if the apparatus 10 is battery operated. Moreover, the display interface 26 may indicate the quality level of the wireless communication between the apparatus 10 and the interface unit 20.

Referring to FIG. 2, the portable weighing apparatus 10 is shown from an elevation standpoint, with a single tip sensor 14 (although a tip sensor could be provided at the other end). The electronic components are at least partially received into the casing of the platform body 13, or molded in the platform body 13 is the latter is a mat. It is considered to provide a ramp surface at the periphery of the platform body 13, for the wheel to move onto the top surface. In an embodiment, the ramp surface 32 is on a base plate supporting the platform body 13. The ramp surface 32 (or two ramp surfaces 32, with ramp surfaces 32 on opposed edges of the platform body 13) is thus peripherally positioned with respect to the platform body 13 so as to facilitate the positioning of the apparatus 10 under the wheel of the vehicle. The wheel will then rest against the loading top surface 34 of the apparatus 10.

Referring to FIG. 5, the weighing apparatus 10 is shown as mounted to a support 36 of a vehicle so as to be used as a fender. In FIG. 5, the weighing apparatus is in a fending position. The support 36 may be motorized so as to lower the apparatus 10 in the weight measuring position.

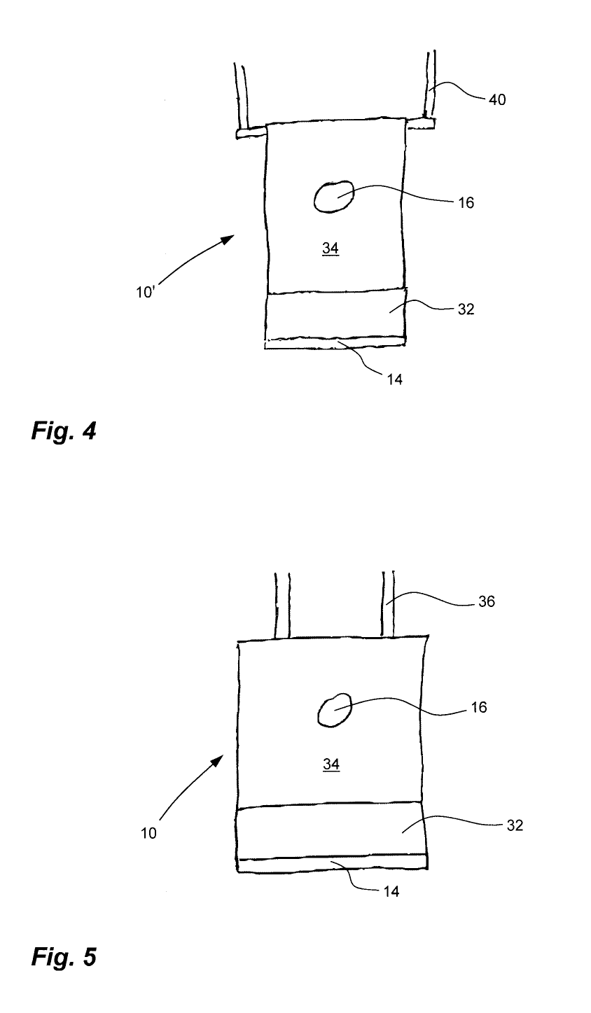

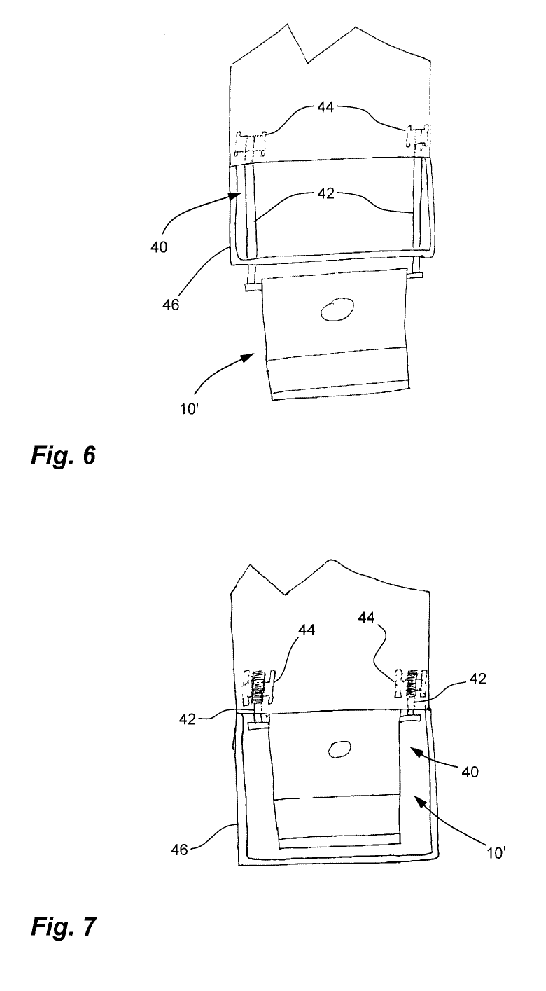

Referring concurrently to FIGS. 4 and 6, an embodiment of the portable weighing apparatus is shown at 10′. The portable weighing apparatus 10′ is similar to the portable weighing apparatus 10, but is secured to an actuator 40. The actuator 40 is a deployable support having a U-shaped configuration with a pair of arms 42. The arms 42 are connected to a pair of rotary motors 44 that retract/deploy the arms 42 in a winding manner. The guide 46 is provided to ensure that the apparatus 10′ is laid on the ground in a desired position when lowered by the deployment of the arms 42. In FIG. 7, the apparatus 10′ is shown in a fending position.

Referring to FIG. 8, there is illustrated a vehicle A having six of the portable weighing apparatus (three visible), with the portable weighing apparatuses 10 being used. During use, the portable weighing apparatuses 10 are detached from their fending position, and are positioned between the wheels of the vehicle A and the ground. When the apparatus 10 contacts the ground, the vehicle may begin to back up toward the arrangement of FIG. 8. It is pointed out that the tip sensor 14 may be used to indicate when the apparatus 10 contacts the ground if the apparatus 10 is used as a fender, directing to the driver that he/she may back up the vehicle for the wheels to mount onto the sensor 10, and stop when the load sensors 16 are triggered.

Referring to FIG. 3, when the portable weighing apparatuses 10 are not used in a weighing function, the portable weighing apparatus 10 are secured to the tractor/trailer and are used as fenders, in their fending position.

Numerous alternatives to the deployable support are considered, whether motorized or manually operated. According to one alternative, the fenders 10 may simply be detached from their support and positioned behind the wheel.

Now that the various components of the portable weighing apparatus 10/10′ have been described, a method for using same is described.

If the apparatus 10/10′ is used as a fender, when it is desired to weigh the vehicle, the apparatuses 10/10′ are deployed from their fending position (FIG. 3), and are gradually moved to the ground. Using the apparatus 10 of FIG. 1, the tip sensors 14 signal to the driver that the vehicle may be backed up. If the apparatus 10 is not a fender, it is simply positioned in front or in back of the wheel/wheelset to be measured.

The vehicle then rolls onto the sensor/apparatuses 10 lying to the ground. The mat sensor 15 and/or the load sensor 16 will indicate to the driver that the wheel/wheelset is correctly positioned on the apparatus 10, for instance via the alarm 19 or via the interface unit 20. The mat sensors 15 may indicate that the wheel is not completely on the platform body 13, whereas the load sensor 16 confirms that the wheel is on the top surface of the platform body 13. When the apparatus 10 is a fender, the vehicle is moved until the position of FIG. 8 is reached, at which point the load sensors 16 will indicate to the driver to stop. At that point, the vehicle may be weighed. The alarm 19 or interface unit 20 may indicate to the driver that the measurement is completed.

If a single portable weighing apparatus 10 is used, the driver positions another wheel/wheelset on the apparatus 10, as described above. This operation is repeated until a weight value is obtained for all wheels/wheelsets of the vehicle. When a single portable weighing apparatus 10 is used in certain conditions (substantially flat terrain), the overall weight of the trailer or vehicle can be approximately obtained by adding each measured weight value for all wheels/wheelsets of the trailer or vehicle.

When multiple apparatuses 10/10′ are used, it is considered to program the interface unit 20 to indicate the backing up and the stop only when all apparatuses 10/10′ have signaled in to the interface unit 20. Also, it is seen in FIG. 8 that the fenders 10′ must be rolled upon by the rearmost wheels to support to foremost wheels of the tandem of wheels. Accordingly, the interface unit 20 may be programmed to take into account the requirement for two signals from the load sensor 16 of the apparatuses 10′ to indicate that the vehicle may stop.

Referring to FIG. 9, the apparatus 10 has a top connection end 50 that is slid into a corresponding support 52. A pin 54 or any other locking system may be used to block the apparatus 10 in the support 52. Optionally, the apparatus 10 may be provided with a rechargeable battery 58, which battery is recharged by the main power system 56 of the vehicle when the apparatus 10 is in the fending position in the support 52.

1. A portable weighing apparatus comprising:
a portable platform body having a top surface sized to be adapted to support at least one wheel of a vehicle/trailer when the platform body lies on the ground;
a weight sensor related to the top surface of the platform body to produce a weight signal as a function of a weight of the wheel and vehicle/trailer on the top surface of the platform body;
a weighing processor to output a weight value from the weight signal; and
at least one load sensor having a trigger portion generally centrally located in a direction on the top surface of the platform body to actuate a measurement from the weight sensor when triggered.

2. The portable weighing apparatus according to claim 1, further comprising at least one peripheral sensor positioned peripherally with respect to the platform body to prevent a measurement from the weight sensor when triggered.

3. The portable weighing apparatus according to claim 1, wherein at least one of the peripheral sensor is a tip sensor projecting laterally from a side of the platform body and adapted to detect the pressure of objects thereon, the tip sensor adapted to support the weight of the wheel when the wheel rolls onto the top surface of the platform body.

4. The portable weighing apparatus according to claim 3, further comprising a ramp surface oriented from the ground to the top surface of the platform body and enclosing the tip sensor.

5. The portable weighing apparatus according to claim 4, comprising two of the ramp surface being positioned on opposed sides of the platform body.

6. The portable weighing apparatus according to claim 1, wherein at least one of the peripheral sensor is a mat projecting beyond at least two sides of the platform body, the mat incorporating sensor means to detect the pressure of objects thereon.

7. The portable weighing apparatus according to claim 1, further comprising an alarm indicating a measurement being taken by the weight sensor.

8. The portable weighing apparatus according to claim 7, wherein the alarm is at least one of an audible alarm, and a visual alarm.

9. The portable weighing apparatus according to claim 1, further comprising an interface in the portable weighing apparatus, the interface outputting the weight value at the portable weighing apparatus.

10. The portable weighing apparatus according to claim 9, wherein the interface comprises at least one of a digital display and a printer.

11. The portable weighing apparatus according to claim 1, wherein the weighing processor comprises memory means to store weight values to calculate a total weight value for the vehicle/trailer after weighing each said wheel.

12. The portable weighing apparatus according to claim 1, further comprising connection means on the portable platform body to removably attach the platform body to the vehicle/trailer as a fender by the connection means.

13. The portable weighing apparatus according to claim 12, wherein the connection means comprise an actuator for displacing the platform body between a fending position and a weighing position.

14. The portable weighing apparatus according to claim 1, further comprising a transmitter for wirelessly transmitting the weight value to an interface unit remotely located with respect to the portable weighing apparatus.

15. A system for weighing a vehicle/trailer, comprising:
at least one of the portable weighing apparatus and comprising:
a portable platform body having a top surface sized to be adapted to support at least one wheel of a vehicle/trailer when the platform body lies on the ground,
a weight sensor related to the top surface of the platform body to produce a weight signal as a function of a weight of the wheel and vehicle/trailer on the top surface of the platform body,
a weighing processor to output a weight value from the weight signal, and
at least one load sensor having a trigger portion generally centrally located in a direction on the top surface of the platform body to actuate a measurement from the weight sensor when triggered; and
an interface unit remotely located with respect to the portable weighing apparatus, the interface unit comprising a processor for obtaining the weight value, and a display interface for displaying the weight remote.

16. The system according to claim 15, wherein the portable weighing apparatus comprises a transmitter for wirelessly transmitting the weight value to an interface unit remotely located with respect to the portable weighing apparatus, and the interface unit comprises a receiver for receiving the weight value from the transmitter of the at least one portable weighing apparatus.

17. The system according to claim 15, wherein the interface unit comprises a weight interpreter for at least one of storing weight values to calculate a total weight value for the vehicle/trailer after weighing each said wheel, and for identifying the one of multiple portable weighing apparatuses sending a weight value.

18. The system according to claim 15, wherein the processor of the interface unit has a distance calculator to calculate a distance between the at least one portable weighing apparatus and the interface unit, and wherein the display interface produces an alarm if the calculated distance is beyond a threshold value.

19. The system according to claim 15, wherein the interface unit receives a signal from the processing unit to display on the display interface that a measurement is being taken by the weight sensor.

20.-23. (canceled)
